(19) United States
(12) Patent Application Publication
(10) Pub. No.: US 2012/0042183 A1
(43) Pub. Date: Feb. 16, 2012

(54) APPARATUS FOR ADJUSTING COMPUTER POWER MODE

(75) Inventor: ZHENG-QUAN PENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/869,712

(22) Filed: Aug. 26, 2010

(30) Foreign Application Priority Data
Aug. 13, 2010 (CN) 201010253028.8

(51) Int. Cl. G06F 1/32

(52) U.S. Cl. 713/323

(57) ABSTRACT

An apparatus includes a setting module setting a preset time, a sensing module, a control module, a power interface connected to a power source to provides powers to the apparatus, and an output interface connected to a computer to output a control signal. The sensing module detects whether a user of the computer has left, outputs a first sensing signal when the user has left, and outputs a second sensing signal when the user comes back. The control module stores the preset time, when the preset time is reduced to zero, and the control module receives the first sensing signal, the control module outputs a sleep signal to the computer, to control the computer to enter a sleep mode. In the sleep mode, the control module outputs a wake signal to the computer according to the received second sensing signal, to control the computer to return to a working mode.

### BACKGROUND

1. Technical Field

The present disclosure relates to power adjusting apparatuses and, particularly, to an apparatus for adjusting a computer's power mode.

2. Description of Related Art

Cost-effective computer systems using power adjusting circuits to save energy have been developed to replace ordinary computer systems. However, most of the computer systems using power adjusting circuits need to manually switch operations, as the users usually forget to do it, resulting in wasting the electrical energy.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of an exemplary embodiment of an apparatus for adjusting computer power mode, the apparatus is connected to a computer and a power source.

FIG. 2 is a block diagram of the apparatus of FIG. 1.

### DETAILED DESCRIPTION

The disclosure, including the drawings, is illustrated by way of example and not by limitation. It should be noted that references to “an” or “one” embodiment in this disclosure are not necessarily to the same embodiment, and such references mean at least one.

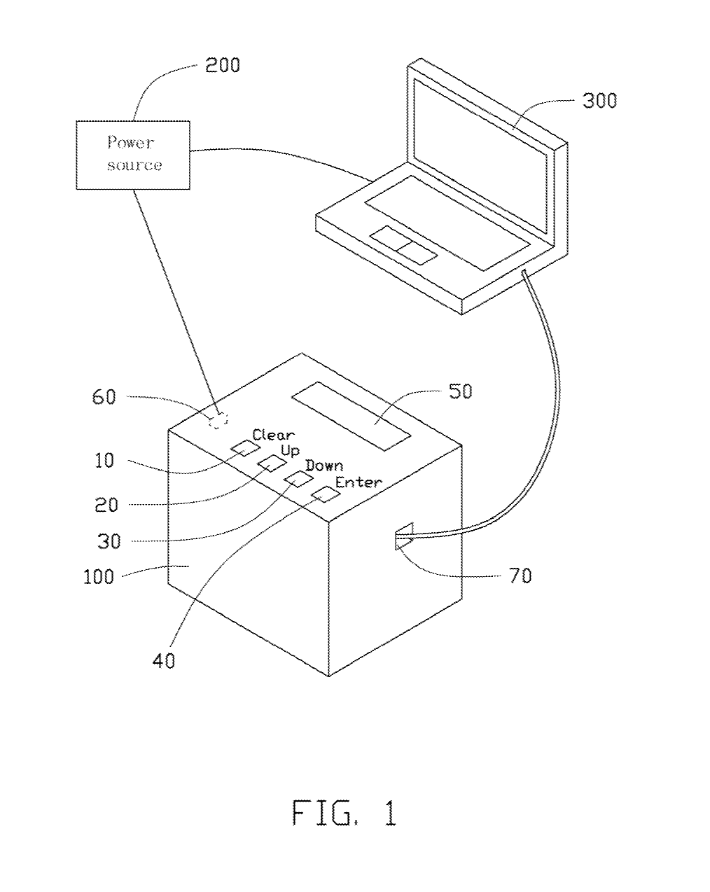

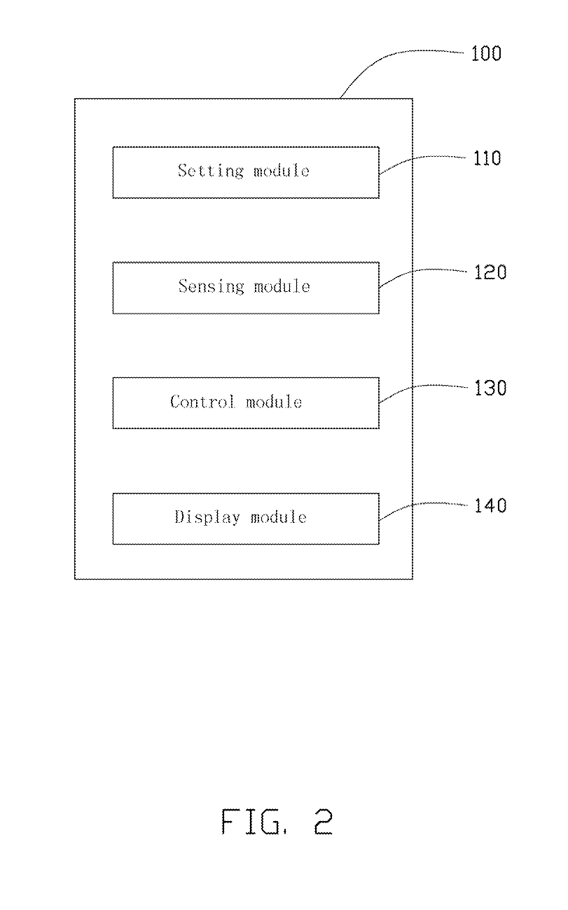

Referring to FIGS. 1 and 2, an embodiment of an apparatus 100 for adjusting computer power mode, the apparatus 100 includes a setting module 110, a sensing module 120, a control module 130, a display module 140, a power interface 60, and an output interface 70. The control module 130 includes an internal storage device to store a preset time. In one embodiment, the output interface 70 is a universal serial bus (USB) interface. The sensing module 120 is an infrared body sensor.

The power interface 60 is connected to a power source 200, to receive voltages from the power source 200 and provide the received voltages to the apparatus 100. The apparatus 100 is connected to a computer 300 through the output interface 70, to output a control signal to a motherboard of the computer 300, to control the computer 300 to enter a sleep mode or return a working mode. A user of the computer 300 sets a preset time through the setting module 110 before the user leaves, and starts a counting function of the apparatus 100 after the preset time is set.

The sensing module 120 detects whether the user has left. When the sensing module 120 detects the user has not left, the sensing module 120 does not output a sensing signal. When the sensing module 120 detects that the user has left, the sensing module 120 outputs a sensing signal to the control module 130. The control module 130 receives the sensing signal and counts down the preset time stored in the internal storage device, and outputs a display signal to the display module 140 to display current states of the computer 300.

When the preset time of the internal storage device of the control module 130 is reduced to zero, and the control module 130 does not receive a sensing signal from the sensing module 120. The control module 130 outputs a sleep signal to the motherboard of the computer 300 through the output interface 70, to control the computer 300 to enter a sleep mode, and outputs a display signal to the display module 140 to display “user left, the computer is in a sleep mode.” In the sleep mode, when the sensing module 120 detects the user comes back, the control module 130 outputs a wake signal to the motherboard of the computer 300 to control the computer 300 to return to a working mode. At the same time, the control module 130 outputs a display signal to the display module 40 to display “the computer is in a working mode.”

The display module 140 includes a liquid crystal display (LCD) 50. The LCD 50 is configured to display the preset time set by the user and current states of the computer 300, such as a sleep mode or a working mode.

The setting module 110 includes a “Clear” button 10, an “Up” button 20, a “Down” button 30, and an “Enter” button 40. In one embodiment, the “Clear” button 10, the “Up” button 20, the “Down” button 40, the “Enter” button 40, and the LCD 50 are set on a surface of the apparatus 100. The preset time can be added by pressing the “Up” button 20. The preset time can be reduced by pressing the “Down” button 30. The counting function can be started by pressing the “Enter” button 40. Display information of the LCD 50 can be cleared by pressing the “Clear” button, and the apparatus 100 can be turned off by pressing the “Clear” button 10.

In use, the apparatus 100 is connected to a power source 200 through the power interface 60, and connected to the computer 300 through the output interface 70. A preset time is set by pressing the “Up” button 20 or the “Down” button 30 of the setting module 110, and the counting function of the apparatus 100 can be started by pressing the “Enter” button 40. The sensing module 110 detects whether the user has left. When the user has left the computer 300, the sensing module 120 outputs a sensing signal to the control module 130. The control module 130 receives the sensing signal and counts time, and outputs a display signal to the LCD 50 to display “user left, count started.”

When the preset time of the internal storage device of the control module 130 is not reduced to zero, the control module 130 receives the sensing signal from the sensing module 120 and resets the count time of the internal storage device of the control module 130, and then outputs a display signal to the LCD 50 to display “user back.” When the preset time of the internal storage device of the control module 130 is reduced to zero, and the control module 130 does not receive the sensing signal from the sensing module 120. The control module 130 outputs a sleep signal to the motherboard of the computer 300 through the output interface 70, to control the computer 300 to enter the sleep mode, and outputs a display signal to the display module 140 to display “user left, the computer is in a sleep mode.” In the sleep mode, when the user comes back, the sensing module 120 detects the user comes back and outputs a sensing signal to the control module 130. The control module 130 outputs an awake signal to the motherboard of the computer 300 according to the received sensing signal, to control the computer 300 to return a working mode. At the same time, the control module 130 outputs a display signal to the display module 140 to display “the computer is in a working mode.”

The sensing module 120 detects whether the user leaves after the preset time is set, and outputs a sensing signal to the control module 130. The control module 130 controls the computer 300 to enter the sleep mode or the working mode, and controls the display module 140 to display the current mode of the computer 300. The apparatus 100 can automatically control the computer 300 to enter a sleep mode when no body is using the computer 300, to save energy.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An apparatus for adjusting a computer's power mode, the apparatus comprising:
a power interface connected to a power source to provide power to the apparatus;
an output interface connected to the computer, to provide a control signal to the computer and control the computer to enter a sleep mode or return to a working mode;
a setting module to set a preset time;
a sensing module to detect whether a user of the computer has left, wherein the sensing module outputs a first sensing signal when the user has left, the sensing module outputs a second sensing signal when the user comes back; and
a control module comprising an internal storage device that stores the preset time, wherein when the preset time of the internal storage device of the control module is reduced to zero after the preset time is set, and the control module receives the first sensing signal, the control module outputs a sleep signal to the computer through the output interface, to control the computer to enter the sleep mode, in the sleep mode, the control module outputs a wakening signal to the computer according to the received second sensing signal from the sensing module, to control the computer to return the working mode.

2. The apparatus of claim 1, further comprising a display module, wherein the control module outputs a display signal to the display module, to control the display module to display the preset time and current states of the computer.

3. The apparatus of claim 2, wherein the display module comprises a liquid crystal display (LCD), the LCD is set on a surface of the apparatus.

4. The apparatus of claim 1, wherein the setting module comprises a “Clear” button, an “Up” button, a “Down” button, and an “Enter” button, the preset time can be added by pressing the “Up” button, the preset time can be reduced by pressing the “Down” button, the counting function can be started by pressing the “Enter” button, display information can be cleared by pressing the “Clear” button, and the counting function can be turned off by pressing the “Clear” button.

5. The apparatus of claim 1, wherein the “Clear” button, the “Up” button, the “Down” button, and the “Enter” button are set on a surface of the apparatus.

6. The apparatus of claim 1, wherein the output interface is a universal serial bus interface.
